(19) United States
(12) Patent Application Publication
(10) Pub. No.: US 2011/0084105 A1
(43) Pub. Date: Apr. 14, 2011

(54) MOUNTING

(75) Inventor: Hubert Koch, Moenchengladbach (DE)

(73) Assignee: TORMAXX GMBH, MOENCHENGLADBACH (DE)

(21) Appl. No.: 12/736,772

(22) PCT Filed: May 5, 2009
(86) PCT No.: PCT/DE2009/000601

§ 371 Date: Nov. 22, 2010

(30) Foreign Application Priority Data
May 9, 2008 (DE) 10 2008 023 083.9
Aug. 8, 2008 (DE) 10 2008 036 983.7
Mar. 26, 2009 (DE) 10 2009 014 412.9

(51) Int. Cl. B60R 11/00

(52) U.S. Cl. 224/559

(57) ABSTRACT

The invention relates to a mounting for fixing a display unit or a computer mounting in the interior of a motor vehicle, said mounting having a telescopic rod, a suction element and a friction element. The mounting element is preferably braced in the interior of the motor vehicle by means of a gas spring, thus acting as a reversible mounting.

The invention relates to a mounting, in particular for attachment in a motor vehicle.

One problem often encountered in a motor vehicle involves the reliable attachment of additional devices, such as computers, displays and other objects of everyday use, inside the passenger compartment. While driving and braking, accelerations arise that can tear the mounting from its attachment, which is why special requirements are placed on such mountings. In addition, it would be advantageous to introduce a mounting that could be used in different vehicles. Finally, this mounting should be easy to attach, without having to introduce significant changes to the passenger compartment of the vehicle.

This gives rise to the object of the invention, which is to propose a mounting that can be easily and securely attached in different motor vehicles.

This object is achieved with a mounting that exhibits a telescopic rod, one end of which has a suction element, and the other end of which has a friction element.

The suction element makes it possible to secure the mounting to, the inside of the windshield in a simple manner. The telescopic rod makes it possible to adjust the mounting to a length corresponding to the distance between the windshield and floor area of the motor vehicle. In the floor area of the motor vehicle, the mounting has a friction element, with which the mounting can easily be attached on the floor covering of the motor vehicle.

As a result, the mounting can be easily attached to the windshield with the suction element, and the telescopic rod can be extended until anchored in the floor.

Tests have surprisingly shown that such mountings are strong enough to securely hold a computer in the motor vehicle, even in crash tests with motor vehicles. To this end, the computer, a housing or a shelf designed for the computer is secured to the telescopic rod, which thereby acts as the mounting for the computer.

It is advantageous for the suction element to have at least one suction cup. Such suction cups are used for transporting windowpanes, for example. In the case at hand, it is favorable to use two opposing suction cups. However, four suction cups can also be used, for example, depending on the requirement and quality of the suction cup. It is especially advantageous for the suction cup to have a lever that makes it easier to attach the suction cup to a smooth surface in a known manner.

In order to provide an easy and reversible way to attach the mounting to the floor of a motor vehicle, it is proposed that the friction element have at least one needle. A pincushion is preferably provided, with which the friction element secured to the lower end telescopic rod can be easily attached to a fabric surface of a motor vehicle floor.

The mounting is secured inside a motor vehicle in an especially simple manner using a telescopic rod with at least one gas spring. The mounting can be transported with the gas spring tensioned, and attached in the motor vehicle. Releasing a latch on the gas spring causes the telescopic rod to lengthen until the friction element abuts the vehicle floor. It is advantageous for the gas pressure to apply a defined force with which the friction element is pressed against the vehicle floor.

In order to absorb impacts and compensate for inclined surfaces, it is proposed that a rubber element be arranged between the suction cup of the suction element and the telescopic rod.

In particular to connect several suction cups with the telescopic rod and enable a relative mobility between the suction cups and telescopic rod, it is proposed that a connecting rod be arranged between a suction cup of the suction element and the telescopic rod.

This connecting rod can be easily hinged with the telescopic rod. For this reason, it is proposed as a further development that the connecting rod be pivoted to the telescopic rod.

In one embodiment, the telescopic rod has a locking device to limit its length. On the one hand, this locking device can keep the telescopic rod collapsed to its minimal length in this position. However, on the other hand, locking devices that fix the telescopic rod at a special length are also possible.

One especially practical embodiment provides that the telescopic rod have a gas spring. The gas spring deploys an unlocked telescopic rod to its maximum length. The length of the telescopic rod is here such that the mounting inside a motor vehicle presses the friction element against the floor of the motor vehicle before the maximum length of the telescopic rod has been reached. This makes it possible to fabricate gas springs with a special contact pressure especially well suited for attaching the mounting inside a motor vehicle.

To offset oscillations, tolerances and irregularities, it is proposed that a rubber element be arranged between the telescopic rod and friction element. This rubber element is preferably designed as a ring placed around the telescopic rod.

In terms of practical application, it is advantageous for the friction element to have a finger guard located in front of the needles. Understandably, a friction element provided with needles may scratch the interior of a motor vehicle. For this reason, a plate with a plurality of boreholes is advantageously provided, which is placed in front of the needles in such a way that the needles do not create a risk of injury, and that the needles can extend through the plate when using the mounting as the mounting is being attached to the motor vehicle, so as to anchor the mounting on the floor of the motor vehicle.

This is achieved in a simple way by varying the position of the finger guard relative to the needles. For example, the finger guard can also be pressed against the force exerted by a spring toward the needles, so that the needles extend through the finger guard, and the finger guard is protectively arranged in front of the needles in the relieved state.

An exemplary embodiment of a mounting is depicted in the drawing, and will be described in greater detail below.

Shown on:

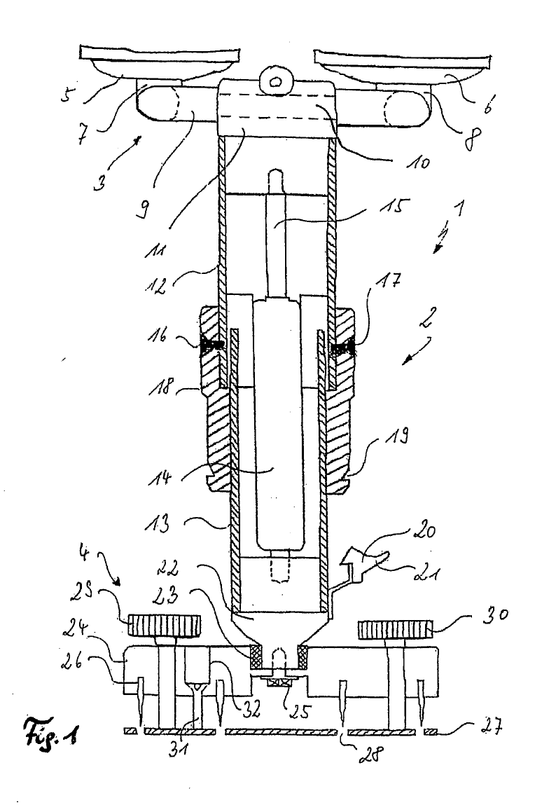

FIG. 1 is a diagrammatic section through a mounting, and on

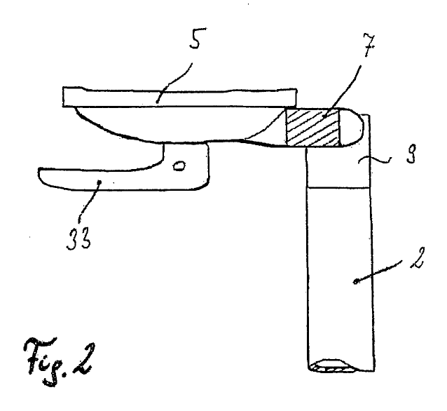

FIG. 2 is a diagrammatic section from FIG. 1, side view.

FIG. 1 shows a mounting 1, which essentially consists of a telescopic rod 2, a suction element 3 and a friction element 4.

The suction element 3 has two adjacent suction cups 5 and 6, which each are joined with a connecting rod 9 via a rubber element 7, 8.

The connecting rod 9 is pivoted to the upper end 10 of the telescopic rod 2. The connecting rod is a fitted rod joined with the telescopic rod 2 in such a way that forces can be transmitted from the suction cups 5, 6 to the telescopic rod 2. A fork head with a safeguard element (not shown) for the connecting rod is used to this end.

The telescopic rod has two telescoping aluminum tubes 12, 13 housed one inside the other, the interior of which accommodates a gas spring 14 with a piston rod 15. The gas spring 14 and piston rod 15 interact in such a way that they can be used to move apart the aluminum tubes 12 and 13 with a defined force.

A guide element 18 extending around the inner aluminum tube 13 is arranged on the outer aluminum tube 12 via screws 16, 17. The lower end of this guide element 18 has a continuous groove 19, which serves as a locking hook.

A locking hook 20 is arranged at the lower end of the inner aluminum rod 13 in such a way that it interacts with the groove 19 and latches there with the aluminum tubes 12 and 13 inserted.

To release the lock, the locking hook 20 has a handle 21, which releases the locking hook 20 from the groove 19, so that the pressure exerted by the gas spring 14 on the piston rod 15 and outer aluminum tube 12 lengthens the telescopic rod.

The lower tube seal 22 at the lower end of the inner aluminum tube 13 is joined with a retaining plate 24 via a rubber element 23. To this end, a screw 25 presses the retaining plate 24 against the tube seal 22.

The retaining plate 24 incorporates 36 needles 26, the tips of which point down. As a result, the retaining plate 24 acts as a movably mounted plate with a plurality of needles attached to the lower end of the telescopic rod.

To prevent injury by the needles 26, a finger guard 27 in the form of a perforated plate is arranged in the area of the tips of the needles 26. This finger guard can be pressed against the retaining plate 24 by springs (not shown), so that the needles 26 exit through openings 28 in the plate 27. The position of the finger guard 27 relative to the retaining plate 24 can be adjusted via knurled screws 29, 30, and the finger guard 27 is guided relative to the retaining plate 24 via pins 31, which are guided in a blind hole 32.

FIG. 2 shows how a suction cup 5 is joined with the connecting rod 9 and telescopic rod 2 via the rubber element 7, while the suction cup 5 can be tensioned with a control lever 33.

When using the mounting 1, the latter is initially attached by means of the control lever 3 and suction cups 5, 6 to the inside of the windshield of a motor vehicle. The locking hook 20 is then released, allowing the pressure exerted by the gas spring 14 to extend the telescopic rod to its maximum length. This maximum length is here dimensioned in such a way that the plate of the finger guard 27 comes to abut a rubber film in the floor area of the motor vehicle. Releasing the knurled screws 29 and 30 presses the retaining plate 24 with the needles 26 against the floor covering of the motor vehicle in such a way that the needles 26 become anchored in the felt-like fabric covering on the floor of the motor vehicle.

Once the mounting 1 has been securely attached in the motor vehicle as a result, a device such as a computer mounting or display device can be secured at any position on the telescopic rod.

1. A mounting, in particular for attachment in a motor vehicle, with a telescopic rod, one end of which has a suction element, and the other end of which has a friction element.

2. The mounting according to claim 1, wherein the suction element has at least one suction cup.

3. The mounting according to claim 1, wherein the friction element has at least one needle.

4. The mounting according to claim 1, wherein the telescopic rod has at least one gas spring.

5. The mounting according to claim 1, wherein a rubber element is arranged between the suction cup of the suction element and the telescopic rod.

6. The mounting according to claim 1, wherein a connecting rod is arranged between the suction cup of the suction element and the telescopic rod.

7. The mounting according to claim 6, wherein the connecting rod is pivoted on the telescopic rod.

8. The mounting according to claim 1, wherein the telescopic rod has a locking device to limit its length.

9. The mounting according to claim 1, wherein the telescopic rod has a gas spring.

10. The mounting according to claim 1, wherein a rubber element is arranged between the telescopic rod and friction element.

11. The mounting according to claim 1, wherein the friction element has a finger guard arranged in front of needles.

12. The mounting according to claim 12, wherein the position of the finger guard relative to the needles can be varied.
